(19) United States
(12) Patent Application Publication
(10) Pub. No.: US 2014/0298727 A1
(43) Pub. Date: Oct. 9, 2014

(54) STRUCTURE OF BEHICLE DOOR FRAME AND METHOD FOF MANUFACTURING VEHICLE DOOR FRAME

(71) Applicants: Katsuhisa FUKUI, Toyokawa-shi (JP); Tadashi MUTOH, Toyohashi-shi (JP); Atsuo NODA, Toyohashi-shi (JP); Kazuyoshi YOKOTA, Gamagori-shi (JP)

(72) Inventors: Katsuhisa FUKUI, Toyokawa-shi (JP); Tadashi MUTOH, Toyohashi-shi (JP); Atsuo NODA, Toyohashi-shi (JP); Kazuyoshi YOKOTA, Gamagori-shi (JP)

(73) Assignee: SHIROKI CORPORATION, Fujisawa-shi (JP)

(21) Appl. No.: 14/311,513

(22) Filed: Jun. 23, 2014

Related U.S. Application Data
(62) Division of application No. 13/446,502, filed on Apr. 13, 2012.
Application No. 13/446,502 is a continuation of application No. PCT/JP2010/067723, filed on Oct. 8, 2010.

(30) Foreign Application Priority Data
Oct. 14, 2009 (JP) 2009-237090

(51) Int. Cl. B60J 5/00

(52) U.S. Cl. CPC B60J 5/00
USPC 49/506

(57) ABSTRACT

A door frame, a frame body including a glass opposing portion, a design portion on one side of the glass opposing portion and a tubular portion positioned on the other side thereof, is structured as a single member continuous from an upper sash portion to a side sash portion by forming the tubular portion to have a uniform cross section and by a bending process performed on a corner portion. The design portion is covered with an exterior member including an inwardly projecting portion projecting toward the inner periphery of the door frame and folding back, and a glass guide portion having a concave cross section is configured from the inwardly projecting portion of the exterior member and the design portion, the tubular portion and the glass opposing portion. The width of the inwardly projecting portion of the exterior member varies.

### RELATED APPLICATION DATA

This is a continuation of International Application No. PCT/JP2010/067723, with an international filing date of Oct. 8, 2010, which is herein incorporated by reference in its entirety.

### TECHNICAL FIELD

The present invention relates to a vehicle door frame structure and a method of producing the vehicle door frame.

### BACKGROUND ART

FIG. 10 shows a front left door of a passenger vehicle, viewed from the vehicle exterior side. The door 50 is provided with a door panel 51 and a door frame 52 positioned on top of the door panel 51, and the area which is surrounded by the upper edge of the door panel 51 and the inner edge of the door frame 52 is defined as a window opening 53. A door glass 54 is installed in the window opening 53 to be movable up and down.

As shown in FIG. 11, a glass guide portion 55 having a U-shaped (concave-shaped) cross section which is open toward the window opening 53 is formed on the inner periphery of the door frame 52, and an outer periphery of the door glass 54 enters the glass guide portion 55 when the door glass 54 closes the window opening 53. A glass run 56 made of an elastic material is fitted in and held by the glass guide portion 55, and the edge of the door glass 54 which has entered the glass guide portion 55 is elastically held by lips 56a and 56b of the glass run 56 therebetween from the vehicle interior side and the vehicle exterior side, respectively. Note that FIG. 11 shows the lips 56a and 56b in a free state, in which the lips 56a and 56b are in noncontact with the door glass 54; the lips 56a and 56b are elastically deformed in directions away from each other when contacting the door glass 54. The glass guide portion 55 is provided on the vehicle interior side with a side wall portion 55a which supports the lip 56a and provided on the vehicle exterior side with a side wall portion 55b which supports the lip 56b on the vehicle exterior side.

The door frame 52 is provided with an upper sash 57 which forms the upper edge of the door and a side sash 58 which extends upwards from the rear of the door panel 51. Although a cross-section structure of the side sash 58 is shown in FIG. 11, the upper sash 57 also has a similar door glass holding structure composed of the glass guide portion 55 and the glass run 56. In addition, it is sometimes the case that the width for holding the door glass 54 by the glass guide portion 55 (the amount of overlapping between the door glass 54 and the side wall portions 55a and 55b) in the upper sash 57 and the width for holding the door glass 54 by the glass guide portion 55 (the amount of overlapping between the door glass 54 and the side wall portions 55a and 55b) in the side sash 58 are made different from each other. For instance, in the side sash 58, it is sometimes required to enhance the retention capability by increasing the width for holding the door glass by the glass guide portion 55 so as to prevent the door glass 54 from vibrating and rattling in a half-open state, whereas in the upper sash 57 it is sometimes required to reduce the width for holding the door glass by the glass guide portion 55 (especially the side wall portion 55b) so as to narrow the width of the design portion outwardly exposed.

To satisfy such demands, in Patent Literature 1, a frame portion of the upper sash and a frame portion of the side sash are formed as separate members having mutually different glass-holding widths in the glass guide portion and joined to each other at a corner portion of the door frame which corresponds to the boundary between the upper sash and the side sash.

### CITATION LIST

### Patent Literature

Patent literature 1: Japanese Unexamined Patent Publication 2007-137200

### SUMMARY OF THE INVENTION

### Technical Problem

To form a frame which includes the glass guide portion from two separate members, one for the upper sash and the other for the side sash, and thereafter to join these two separate members to each other is costly and troublesome to produce, and reduction thereof has been desired. Accordingly, the present invention provides a vehicle door frame structure which is low in production cost, high in productivity, and superior in flexibility of the setting of the cross sectional shape of the frame at different portions in the lengthwise direction of the frame, especially in the width of the design portion and the glass holding width.

### Solution to Problem

The present invention provides a vehicle door frame structure which includes an upper sash portion that holds an upper edge of an upward/downward movable door glass, a side sash portion that holds a side edge of the door glass and a corner portion positioned at a boundary between the upper sash portion and the side sash portion, the vehicle door frame structure including

a frame body which includes a glass-opposing portion that is opposed to an edge of the door glass, a design portion that is positioned on one side of the glass-opposing portion on a vehicle exterior side and a tubular portion that is positioned on the other side of the glass-opposing portion on a vehicle interior side, wherein the frame body is structured as a single member which is continuous from the upper sash portion to the side sash portion by forming the tubular portion to have a uniform cross section over a range from the upper sash portion to the side sash portion and by performing a bending process on the corner portion;

an exterior member which covers the design portion of each of the upper sash portion and the side sash portion of the frame body from the vehicle exterior side, and includes an inwardly projecting portion which projects in a direction toward an inner periphery of the door frame further than the design portion of the frame body and which is folded back toward the vehicle interior side; and,

a glass guide portion which has a concave-shaped cross section, wherein a base of the glass guide portion is formed by the glass-opposing portion of the frame body, wherein a side wall of the glass guide portion on the vehicle exterior side is formed by the design portion of the frame body and the inwardly projecting portion of the exterior member, wherein a side wall of the glass guide portion on the vehicle interior side is formed by the tubular portion of the frame body, and wherein the edge of the door glass enters between the side walls on both the vehicle exterior side and the vehicle interior side,

wherein a projection width of the inwardly projecting portion of the exterior member in the direction toward the inner periphery of the door frame is made to vary at at least one area along the length thereof.

It is desirable for the projection width of the inwardly projecting portion of the exterior member in the direction toward the inner periphery of the door frame to be greater in the side sash portion than in the upper sash portion.

The inwardly projecting portion of the exterior member can be formed from a hemmed portion which clamps the design portion of the frame body between the area of a design surface positioned on the vehicle exterior side and a folded area on the vehicle interior side or from an empty hemmed portion which allows the folded area on the vehicle interior side to face the area of the design surface that is positioned on the vehicle exterior side.

The present invention also provides a method of producing a vehicle door frame which includes an upper sash portion that holds an upper edge of an upward/downward movable door glass, a side sash portion that holds a side edge of the door glass and a corner portion positioned at a boundary between the upper sash portion and the side sash portion, the method including forming a frame body which is continuous from the upper sash portion to the side sash portion by forming a linear member from a metal plate which has a length extending at least from the upper sash portion to the side sash portion so that the linear member has an uniform cross sectional shape which includes a glass-opposing portion that is opposed to an edge of the door glass, a design portion that is positioned on one side of the glass-opposing portion on a vehicle exterior side, and a tubular portion that is positioned on the other side of the glass-opposing portion on a vehicle interior side; and by bending the linear member on the corner portion; covering the design portion of each of the upper sash portion and the side sash portion of the frame body with an exterior member from the vehicle exterior side; forming an inwardly projecting portion which projects in a direction toward an inner periphery of the door frame further than the design portion of the frame body and which is folded back toward the vehicle interior side on the exterior member in a manner to make a projection width of the inwardly projecting portion of the exterior member in the direction toward the inner periphery of the door frame vary at at least one area along the length thereof; and forming a glass guide portion having a concave-shaped cross section from the inwardly projecting portion of the exterior member and the design portion, the tubular portion and the glass-opposing portion of the frame body, wherein the edge of the door glass can enter the glass guide portion.

### Advantages Effects of the Invention

According to the present invention of the above, the production cost can be kept down and an excellent productivity can be exhibited compared to a structure in which separate frames are joined to each other at a corner of the door because the body of the door frame that includes the design portion, the tubular portion and the glass-opposing portion is formed from the frame body that consists of a single member which is continuous from the upper sash portion to the side sash portion and because the outer side of the design portion of the frame body is covered with an exterior member. In addition, the vehicle door frame structure according to the present invention is superior in ensuring the strength of the door frame. Additionally, a design portion width and a glass holding width which are suited for each portion of the frame can be easily set by forming the inwardly projecting portion of the exterior member, which constitutes a wall portion of the glass guide portion 20 on the vehicle exterior side, in a manner to make the projection width of the inwardly projecting portion in an inward direction of the door frame vary at at least one area along the length thereof.

### BRIEF DESCRIPTION OF THE DRAWINGS

FIG. 1 is an exploded perspective view a door frame to which the present invention has been applied;

FIG. 2 is a perspective view showing a cross sectional shape of a portion of an inner frame which serves as an element of the door frame shown in FIG. 1;

FIG. 3 is a cross sectional view of the upper sash portion in a completed state of the door frame, taken along the line A-A shown in FIG. 1;

FIG. 4 is a cross sectional view of the rear side sash portion in a completed state of the door frame, taken along the line B-B shown in FIG. 1;

FIG. 5 is an enlarged perspective view of a front corner portion of the inner frame;

FIG. 6 is an enlarged perspective view of a portion of the door frame in the vicinity of the front corner portion in a completed state of the door frame;

FIG. 7 is an enlarged perspective view of the rear corner portion of the inner frame;

FIG. 8 is an enlarged perspective view of a portion of the door frame in the vicinity of the rear corner portion in a completed state of the door frame;

FIG. 9 is a cross sectional view of the rear side sash portion in a completed state of the door frame in a second embodiment;

FIG. 10 is a diagram showing an outline structure of a vehicle door; and

FIG. 11 is a cross sectional view taken along the line C-C shown in FIG. 10, showing an example of a conventional door frame.

### DESCRIPTION OF THE EMBODIMENT

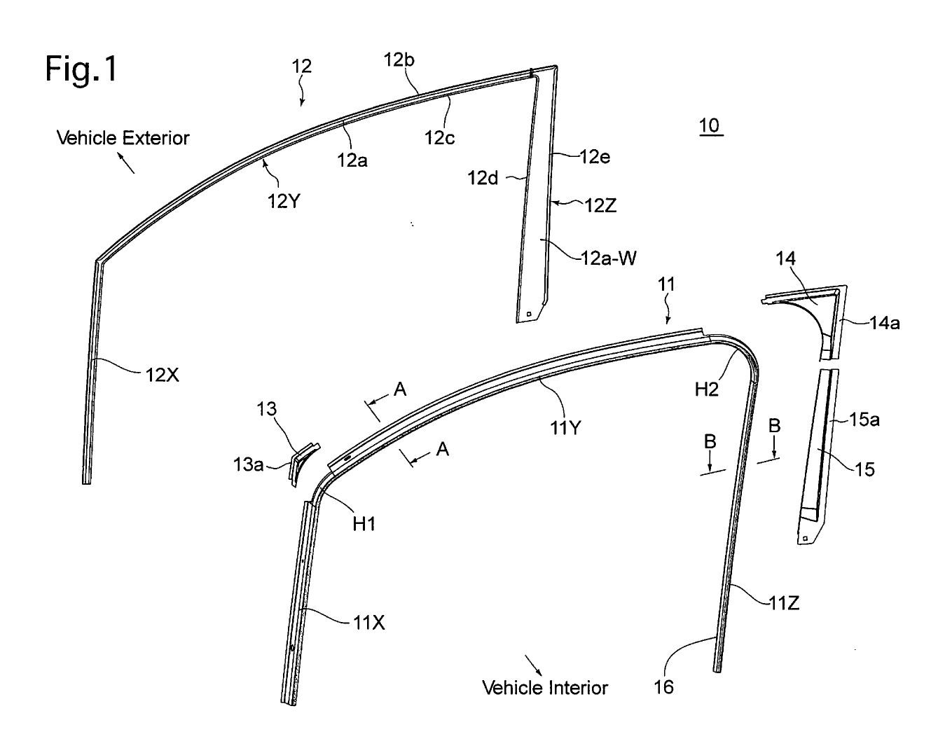

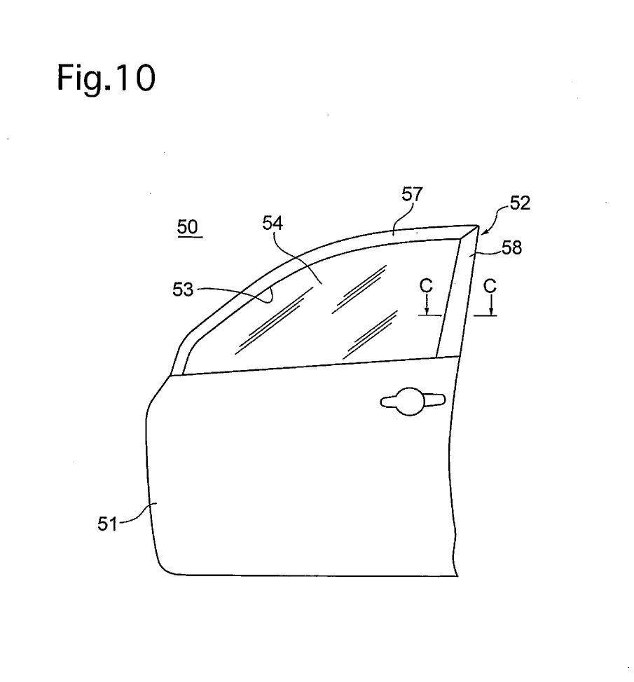

A door frame 10 that is shown in FIG. 1 in an exploded state is a portion corresponding to the door frame 52 of the door 50 that has been described above with reference to FIG. 10. The door frame 10 is applied to a front right door of a passenger vehicle. The door frame 10 is composed of an inner frame (frame body) 11, an exterior member 12, a front corner patch 13, a rear corner patch 14 and a reinforcement member 15.

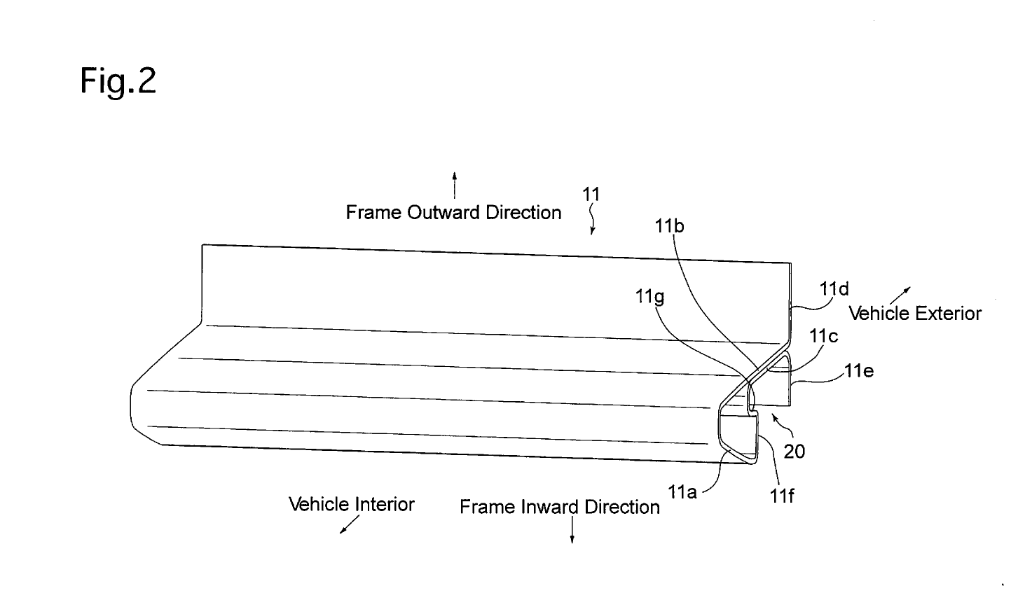

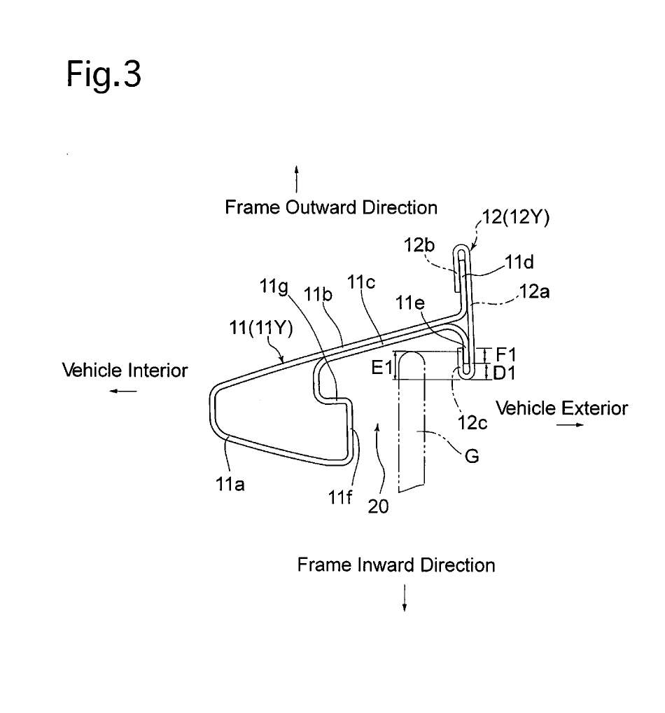

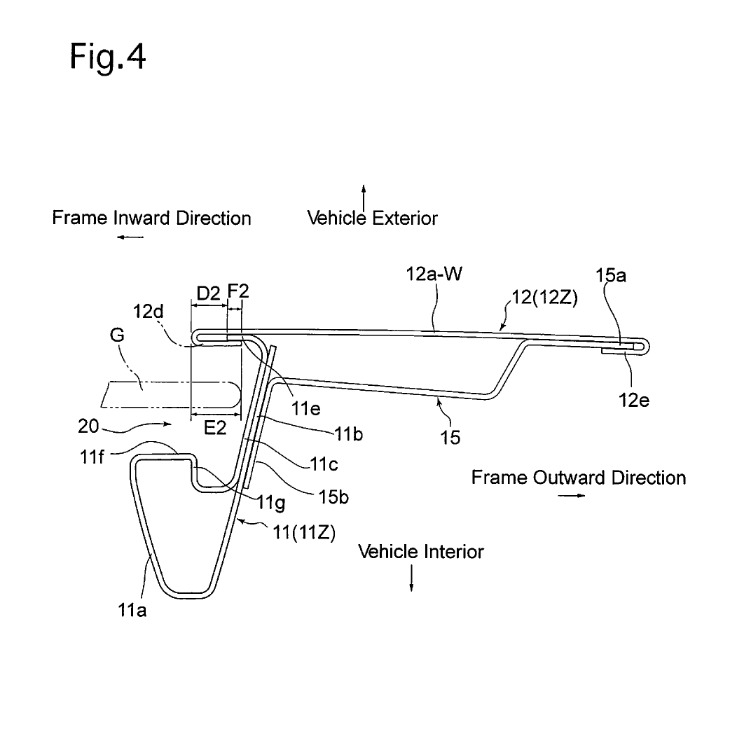

The inner frame 11 is formed of a sheet metal material; firstly formed into a linear member having the cross sectional shape shown in FIGS. 2 through 4 by roll forming process, and subsequently deformed by bending at a front corner portion H1 and a rear corner portion H2 at intermediate points in the lengthwise direction to form a front side sash portion 11X, an upper sash side portion 11Y and a rear side sash portion 11Z. The area surrounded by the front side sash portion 11X, the upper sash side portion 11Y and the rear side sash portion 11Z is defined as a window opening 16 in which a door glass G (FIGS. 3 and 4) is moved up and down. In the following descriptions, the side of the inner frame 11 which faces the window opening 16 is referred to as the inner periphery of the inner frame 11 (the door frame 10) and the opposite side of the inner frame 11 from the inner periphery thereof is referred to as the outer periphery of the inner frame 11. After the completion of the door frame 10, the lower parts of the front side sash portion 11X and the rear side sash portion 11Z are fixed to a door panel not shown in the drawings.

As shown in FIGS. 2 through 4, the inner frame 11 is provided with a tubular portion 11a having a closed cross sectional shape which is positioned on the vehicle interior side; a pair of planate portions (glass-opposing portion) 11b and 11c which extend toward the vehicle exterior side in a direction substantially parallel to the tubular portion 11a; an outer-periphery design portion 11d which is formed by bending the end of the planate portion 11b on the vehicle exterior side toward the outer periphery of the inner frame 11; and an inner-periphery design portion 11e which is formed by bending the end of the planate portion 11c on the vehicle exterior side toward the inner periphery of the inner frame 11. In other words, the inner frame 11 has a structure such that the tubular portion 11a, which is positioned on the vehicle interior side, and the design portions 11d and 11e, which are positioned on the vehicle exterior side, are connected to each other via the planate portions 11b and 11c, respectively, that are opposed to an outer edge of the door glass G. Part of the tubular portion 11a constitutes an upright wall portion 11f which faces the inner-periphery design portion 11e.

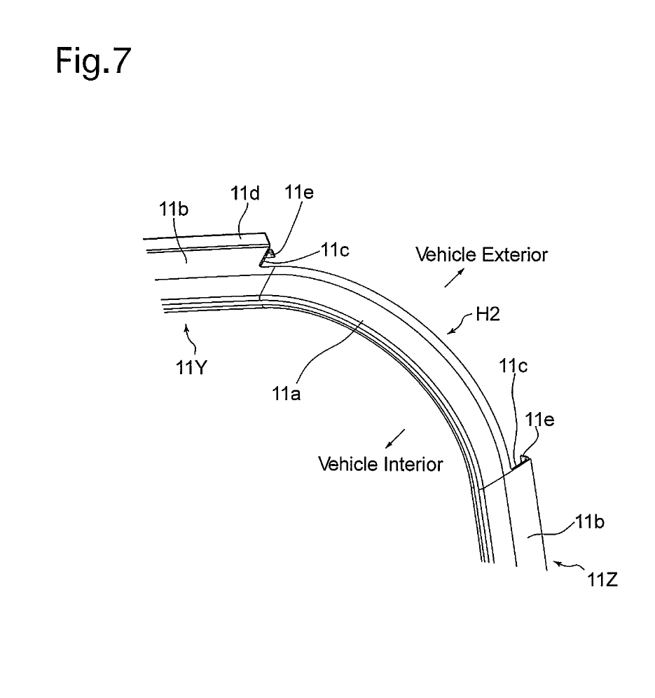

As shown in FIGS. 2, 3 and 5, in the front side sash portion 11X and the upper sash portion 11Y of the inner frame 11, the outer-periphery design portion 11d and the inner-periphery design portion 11e are aligned to be substantially flush with each other so as to constitute a design portion which faces toward the vehicle external side. On the other hand, in the rear side sash portion 11Z, the outer-periphery design portion 11d is cut out, as shown in FIGS. 4 and 7; instead, an outer-periphery design portion 15a (FIG. 4) of the reinforcement member 15 and the inner-periphery design portion 11e constitute a design portion which faces toward the vehicle exterior side. As shown in FIG. 4, the reinforcement member 15 is provided with a support plate portion 15b which extends along the planate portion 11b of the inner frame 11, and the outer-periphery design portion 15a faces toward the vehicle exterior side at a position away from the inner-periphery design portion 11e with the support plate portion 15b fixed to the planate portion 11b.

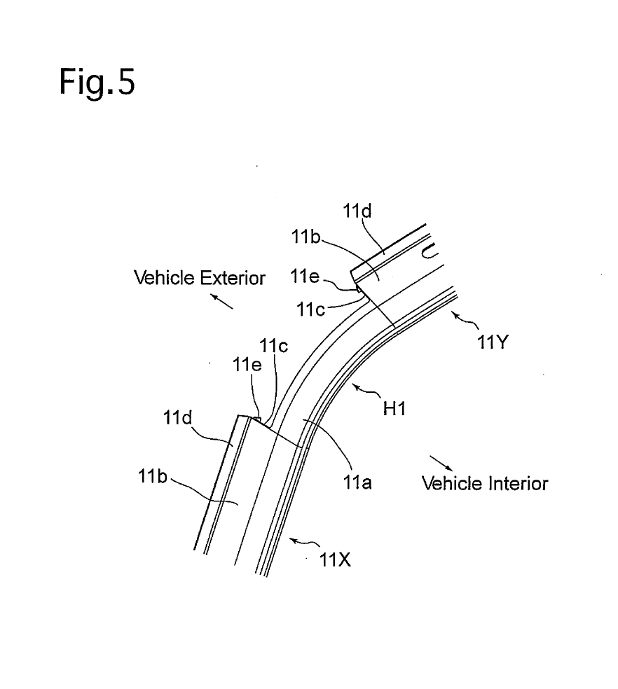

As shown in FIGS. 5 and 7, in the inner frame 11, the design portion (the outer-periphery design portion 11d and the inner-periphery design portion 11e) and a part of the planate portions 11b and 11c are cut out at each of the front corner portion H1, which corresponds to the boundary between the front side sash portion 11X and the upper sash portion 11Y, and the rear corner portion H2, which corresponds to the boundary between the upper sash portion 11Y and the rear side sash portion 11Z, so that only the entire part of the tubular portion 11a and part of the planate portions 11b and 11c remain. This cutting out of the design portion is carried out after bending process for forming each corner portion H1 and H2 is performed on the inner frame 11, thereby removing improperly deformed portions such as wrinkles created by the aforementioned bending process. Since the tubular portion 11a remains at each corner portion H1 and H2, the inner frame 11 as a whole can secure a sufficient strength even if the design portion is cut out.

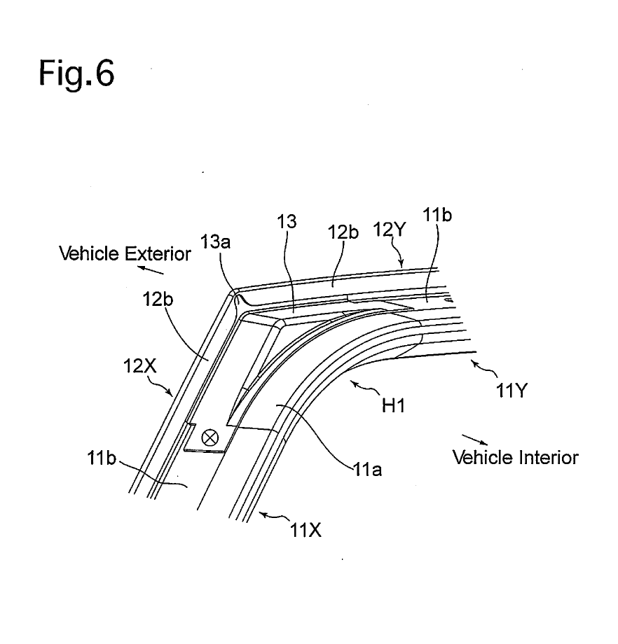

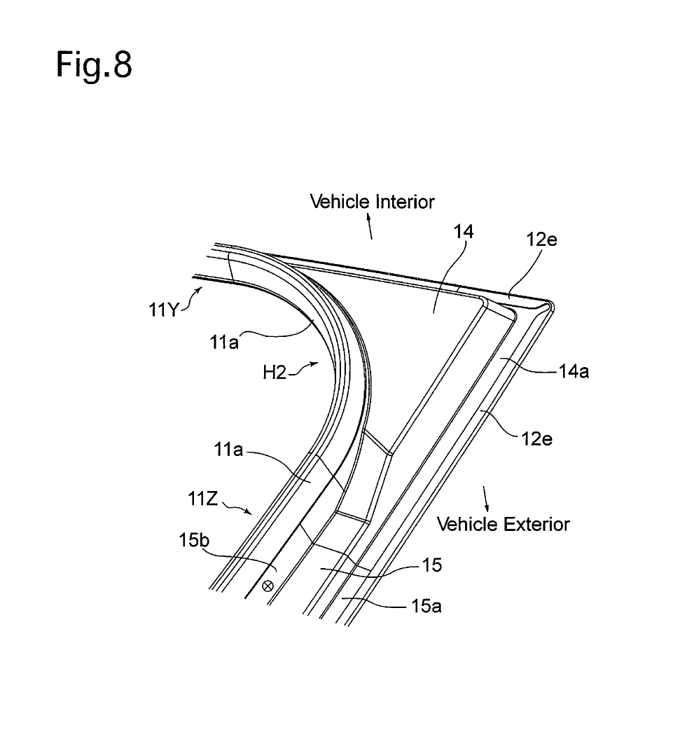

The front corner patch 13 and the rear corner patch 14 are installed to the front corner portion H1 and the rear corner portion H2 of the inner frame 11, respectively. The front corner patch 13 is provided with a connection design portion 13a (partly shown in FIGS. 1 and 6) which is substantially flush with the outer-periphery design portion 11d and the inner-periphery design portion 11e of the inner frame 11 in a state where the front corner patch 13 is fixed to the front corner portion H1. The rear corner patch 14 is provided with a connection design portion 14a (partly shown in FIGS. 1 and 8) which is substantially flush with the inner-periphery design portion 11e of the inner frame 11 and the outer-periphery design portion 15a of the reinforcement member 15 in a state where the rear corner patch 14 is fixed to the rear corner portion H2.

The exterior member 12 for covering these design portions is installed in a state where each corner patch 13 and 14 and the reinforcement member 15 are installed to the inner frame 11 as described above. As shown in FIG. 1, the exterior member 12 is provided with a front side portion 12X, an upper portion 12Y and a rear side portion 12Z which are formed to correspond to the front side sash portion 11X, the upper sash portion 11Y and the rear side sash portion 11Z of the inner frame 11, respectively. The exterior member 12 is brought into contact with the design portions (11d, 11e, 13a, 14a and 15a) of the inner frame 11, the front and rear corner patches 13 and 14 and the reinforcement member 15 from the vehicle external side and fixed thereto by hemming, in which both edges of the exterior member 12 are folded back toward the vehicle interior side.

Specifically, the exterior member 12 is formed so that the rear side portion 12Z is greater in width than the front side portion 12X and the upper portion 12Y. As shown in FIG. 3, the upper portion 12Y of the exterior member 12 is joined to the upper sash portion 11Y of the inner frame 11 by clamping the outer-periphery design portion 11d and the inner-periphery design portion 11e with an outer-periphery hemmed portion 12b and an inner-periphery hemmed portion (inwardly projecting portion) 12c, respectively, which are formed by folding back the outer and inner peripheral edges of a design surface 12a toward the vehicle interior side with the design surface 12a brought in contact with vehicle external side surfaces of the outer-periphery design portion 11d and the inner-periphery design portion 11e. Although a detailed cross sectional shape is omitted, the joining structure of the front side portion 12X of the exterior member 12 to the front side sash portion 11X is similar to this joining structure (see FIG. 6).

As shown in FIG. 4, the rear side portion 12Z of the exterior member 12 is joined to the inner frame 11 by clamping the inner-periphery design portion 11e with an inner-periphery hemmed portion (inwardly projecting portion) 12d that is formed by folding the inner peripheral edge of a wide design surface 12a-W back toward the vehicle interior side with the wide design surface 12a-W brought in contact with vehicle external side surfaces of the outer-periphery design portion 15a of the reinforcement member 15 and the inner-periphery design portion 11e of the inner frame 11 so as to extend over these vehicle external side surfaces. On the other hand, the rear side portion 12Z of the exterior member 12 is joined to the reinforcement member 15 by clamping the outer-periphery design portion 15a with an outer-periphery hemmed portion 12e that is formed by folding back the outer peripheral edge of the wide design surface 12a-W toward the vehicle interior side.

Additionally, in the front corner portion H1, the exterior member 12 and the front corner patch 13 are joined to each other by clamping the connection design portion 13a of the front corner patch 13 with the outer-periphery hemmed portion 12b and the inner-periphery hemmed portion 12c of each of the front side portion 12X and the upper portion 12Y (see FIG. 6). In the rear corner portion H2, the exterior member 12 and the rear corner patch 14 are joined to each other by clamping the connection design portion 14a of the rear corner patch 14 with the outer-periphery hemmed portion 12b and the inner-periphery hemmed portion 12c of the upper portion 12Y and the inner-periphery hemmed portion 12d and the outer-periphery hemmed portion 12e of the rear side portion 12Z (see FIG. 8).

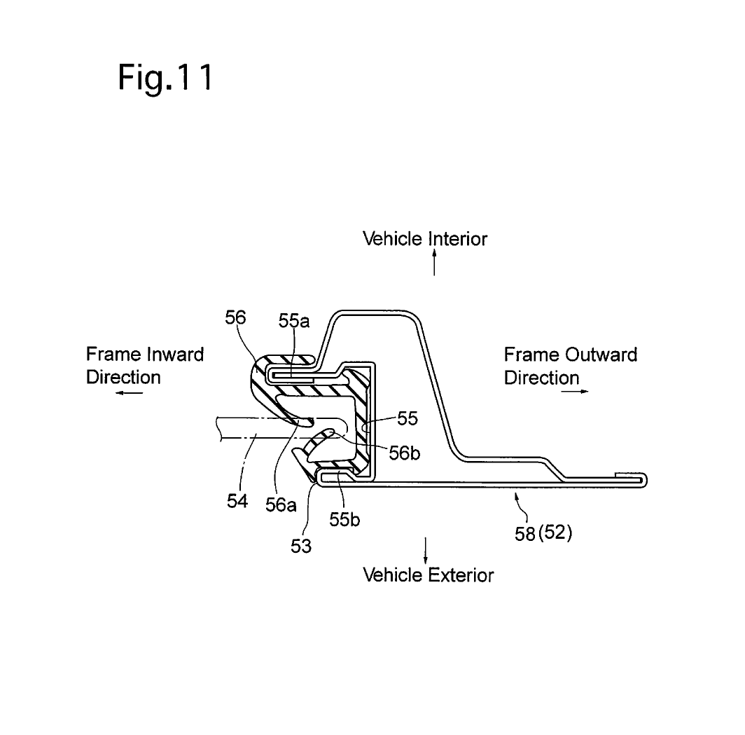

A glass guide portion 20 having a concave-shaped cross section which is open to the window opening 16 (toward the inner-periphery of the frame) is formed on the inner edge of the door frame 10, wherein the inner-periphery design portion 11e of the inner frame 11 and the inner-periphery hemmed portions 12c and 12d of the exterior member 12 serve as side walls of the glass guide portion 20 on the vehicle exterior side, wherein the upright wall portion 11f of the inner frame 11 serves as a side wall of the glass guide portion 20 on the vehicle interior side, and wherein the planate portion 11c of the inner frame 11 serves as the base of the glass guide portion 20. Although not shown in the drawings, a glass run made of an elastic material is held in the glass guide portion 20. Similar to the glass run 56 shown in FIG. 11, this glass run has lips which elastically hold, from the vehicle interior side and the vehicle exterior side, both sides of an edge of the door glass G which has entered the glass guide portion 20. A stepped portion 11g as a retainer which retains the glass run is formed on the upright wall portion 11f.

As described above, since the door frame 10 has a structure such that the basic form of the door frame is configured by the inner frame 11, which is composed of a single member, over the whole of the front and rear side sash portions and the upper sash portion and that only the outer surface of the design portion of the door frame 10 is covered by the exterior member 12, the door frame 10 can be easily assembled and produced at low cost and is superior in strength compared with a structure in which separate frame members are joined to each other at a door corner portion.

In the inner frame 11, the outer-periphery design portion 11d and the inner-periphery design portion 11e are cut out at the front corner portion H1 and the rear corner portion H2 while the outer-periphery design portion 11d is cut out at the rear side sash portion 11Z; however, other parts have a uniform cross sectional shape over the whole of the inner frame 11 in the lengthwise direction thereof. Namely, the width (amount of projection in a direction toward the inner periphery of the frame) of the inner-periphery design portion 11e, which forms a part of the side walls of the glass guide portion 20 on the vehicle exterior side, is to the same as the upper sash portion 11Y and the rear side sash portion 11Z. On the other hand, in the exterior member 12, the projection width (amount of projection) of the inner-periphery hemmed portions 12c and 12d that project in a direction toward the inner periphery of the frame further than the inner-periphery design portion 11e varies between the upper portion 12Y and the rear side portion 12Z. More specifically, as shown in FIGS. 3 and 4, the width F1 of the clamped area of the design portion 11e of the upper sash portion 11Y by the design surface 12a and the inner-periphery hemmed portion 12c of the upper portion 12Y and the width F2 of the clamped area of the design portion 11e of the rear side sash portion 11Z by the wide design surface 12a-W and the inner-periphery hemmed portion 12d of the rear side portion 12Z are substantially the same as each other, and the projection width D1 of the inner-periphery hemmed portion 12c in a direction toward the inner periphery of the frame beyond the clamped area of the design portion 11e of the upper sash portion 11Y and the projection width D2 of the inner-periphery hemmed portion 12d in a direction toward the inner periphery of the frame beyond the clamped area of the design portion 11e of the rear side sash portion 11Z are mutually different. As can be seen from a comparison between FIGS. 3 and 4, the projection width D2 of the inner-periphery hemmed portion 12d on the rear side portion 12Z side is greater than the projection width D1 of the inner-periphery hemmed portion 12c on the upper portion 12Y side (D1<D2). Due to this difference between the projection widths D1 and D2 of the inner-periphery hemmed portions 12c and 12d in the exterior member 12, the overlapping width E1 (FIG. 3) between the door glass G which enters the glass guide portion 20 and the inner-periphery hemmed portion 12c on the upper sash side (11Y, 12Y) and the overlapping width E2 (FIG. 4) between the door glass G which enters the glass guide portion 20 and the inner-periphery hemmed portion 12d on the side sash side (11Z, 12Z) satisfy a condition E1<E2. In other words, since the inner-periphery hemmed portions 12c and 12d constitute a side wall of the glass guide portion 20 on the vehicle external side, the width (E2) for holding the door glass G by a vehicle exterior side wall surface of the glass guide portion 20 on the side sash side (11Z, 12Z) becomes greater than the width (E1) for holding the door glass G by a vehicle exterior side wall surface of the glass guide portion 20 on the upper sash side (11Y, 12Y). With this structure, the installation of the glass run (not shown) to the glass guide portion 20 increases the holding strength for the door glass G to thereby make it possible to reliably prevent the door glass G from vibrating and rattling in the rear side sash portion (11Z, 12Z) of the door frame 10. On the other hand, in the upper sash portion (11Y, 12Y) of the door frame 10, the width of the design surface 12a of the exterior member 12 can be reduced to thereby increase the degree of freedom in design of the door frame 10. Since the door glass G is in the fully closed state when the upper edge of the door glass G enters the glass guide portion 20 on the upper sash side, the door glass G can be held with a narrow holding width (E1) with a sufficient degree of stability, unlike the rear side sash side, on which it is required to hold the door glass G even in a half-open state thereof.

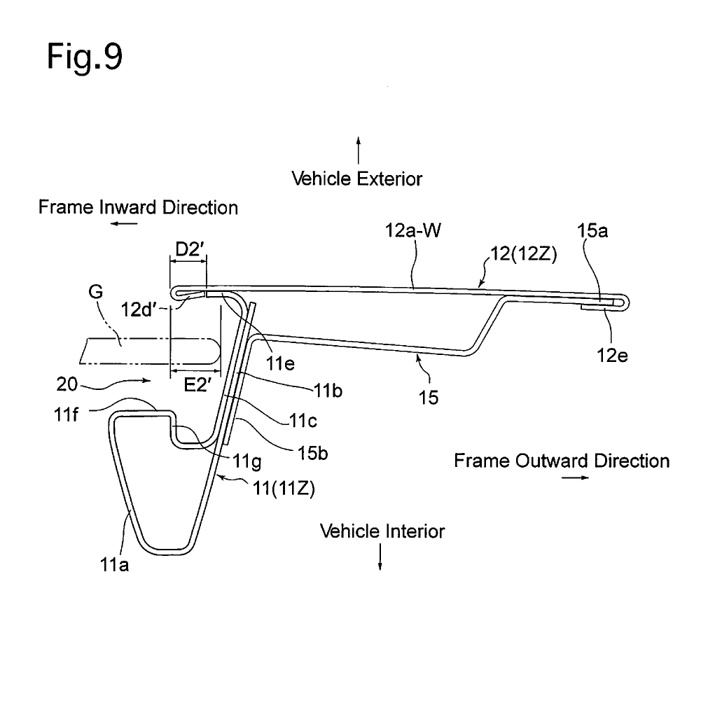

Although each of the inner-periphery hemmed portions 12c and 12d of the exterior member 12 that form a wall portion of the glass guide portion 20 on the vehicle exterior side clamps the inner-periphery design portion 11e of the inner frame 11 in the above described embodiment, part of the inner-periphery hemmed portions can be configured as a so-called empty hemmed portion (inwardly projecting portion) 12d′ which does not clamp the inner-periphery design portion 11e as shown in FIG. 9. FIG. 9 shows an embodiment in which the empty hemmed portion 12d′ is formed on the rear side portion 12Z. The width of the rear side portion 12Z gradually varies in a manner to decrease gradually in a direction from the lower part to the upper part (portion connected to the upper part 12Y) as shown in FIG. 1, and the inner-periphery hemmed portion 12d that clamps the inner-periphery design portion 11e can be formed in an area of the rear side portion 12Z as shown in FIG. 4 while the empty hemmed portion 12d′, which is folded so as to come in contact with (so as to face) the back of the design surface 12a without clamping the inner-periphery design portion 11e, can be formed in another area of the rear side portion 12Z. In this embodiment also, the overlapping width E2′ between the door glass G which enters the glass guide portion 20 and the empty hemmed portion 12d′ can be made greater than the aforementioned overlapping width E1 by making the projection width D2′ (FIG. 9) of the empty hemmed portion 12d′ in a direction toward the inner periphery of the frame greater than the projection width D1 of the inner-periphery hemmed portion 12c of the upper portion 12Y.

Although FIG. 9 shows an embodiment in which the empty hemmed portion 12d′ is formed on the rear side portion 12Z side, in the present invention, in the case where an empty hemmed portion is formed on the exterior member 12, the formation area of the empty hemmed portion is not limited to the rear side portion 12Z; the empty hemmed portion can also be formed on the front side portion 12X or the upper portion 12Y. Namely, regardless of whether or not the hemmed portion clamps the design portion 11e of the inner frame 11, what is essential is to provide variations to the width of the design portion of the door frame 10 or the width for holding the door glass G by the glass guide portion 20 by making the projection width of the projecting portion of the exterior member 12 in a direction toward the inner periphery of the frame vary between the upper portion 12Y side and the rear side portion 12Z side.

Although described above based on the illustrated embodiment, the present invention is not limited to this embodiment. For instance, although the inner frame 11 includes the front side sash portion 11X that bends at the front corner portion H1 with respect to the upper sash portion 11Y in the present embodiment of the door frame 10, the present invention can also be applied to a type of door frame in which the inner frame includes no bent portion corresponding to the front corner portion H1 and in which the upper sash portion is gently curved to be connected to a door panel.

Additionally, although the outer-periphery design portion 11d is cut out from the rear side sash portion 11Z of the inner frame 11 in the present embodiment, it is possible to leave the outer-periphery design portion 11d in the rear side sash portion 11Z to make the rear side sash portion 11Z have substantially the same cross section as the front side sash portion 11X and the upper sash portion 11Y. In this case, it is also possible to form the design portion of the rear side sash portion 11Z solely by the inner frame 11 (the outer-periphery design portion 11d and the inner-periphery design portion 11e) without using the reinforcement member 15.

Additionally, although the tubular portion 11a of the inner frame 11 of the present embodiment is formed to have a closed cross section, the present invention can also be applied to a door frame provided with a tubular portion having no closed cross section.

### INDUSTRIAL APPLICABILITY

As described above in details, the present invention relates to a door frame structure applied to a vehicle such as an automobile and a method of producing the door frame, and a reduction in production cost, an improvement in productivity and an improvement in strength of the door frame can be achieved by forming the body of the door frame from a frame body consisting of a single member which is continuous from the upper sash portion to the side sash portion. In addition, it is possible to increase the degree of freedom in vehicle design while securing the door glass holding capability by setting a design portion width and a glass holding width which are suited for each portion of the frame by forming the inwardly projecting portion of the exterior member, which constitutes a wall portion of the glass guide portion 20 on the vehicle exterior side, in a manner to make the projection width of the inwardly projecting portion in an inward direction of the door frame vary at at least one point in the lengthwise direction thereof.

### DESCRIPTION OF THE REFERENCE NUMERALS

10 Door frame

11 Inner frame (frame body)

11a Tubular portion

11b 11c Planate portion (glass-opposing portion)

11d Outer-periphery design portion

11e Inner-periphery design portion

11f Upright wall portion

11g Stepped portion

11X Front side sash portion

11Y Upper sash portion

11Z Rear side sash portion

12 Exterior member

12a 12a-W Design surface

12b 12e Outer-periphery hemmed portion

12c 12d Inner-periphery hemmed portion (inwardly projecting portion)

12d′ Empty hemmed portion (inwardly projecting portion)

12X Front side portion

12Y Upper portion

12Z Rear side portion

13 Front corner patch

13a Connection design portion

14 Rear corner patch

14a Connection design portion

15 Reinforcement member

15a Outer-periphery design portion

15b Support plate portion

16 Window opening

20 Glass guide portion

G Door glass

H1 Front corner portion

H2 Rear corner portion

1-4. (canceled)

5. A method of producing a vehicle door frame which includes an upper sash portion that holds an upper edge of an upward/downward movable door glass, a side sash portion that holds a side edge of said door glass and a corner portion positioned at a boundary between said upper sash portion and said side sash portion, said method comprising:
forming a frame body which is continuous from said upper sash portion to said side sash portion by forming a linear member from a metal plate which has a length extending at least from said upper sash portion to said side sash portion so that said linear member has an uniform cross sectional shape which includes a glass-opposing portion that is opposed to an edge of said door glass, a design portion that is positioned on one side of said glass-opposing portion on a vehicle exterior side, and a tubular portion that is positioned on the other side of said glass-opposing portion on a vehicle interior side; and by bending said linear member on said corner portion;
covering said design portion of each of said upper sash portion and said side sash portion of said frame body with an exterior member from said vehicle exterior side after said frame body having been formed;
forming an inwardly projecting portion which projects in a direction toward an inner periphery of said door frame further than said design portion of said frame body and which is folded back toward said vehicle interior side on said exterior member in a manner to make a projection width of said inwardly projecting portion of said exterior member in said direction toward said inner periphery of said door frame vary at least one area along the length thereof; and
forming a glass guide portion having a concave-shaped cross section from said inwardly projecting portion of said exterior member and said design portion, said tubular portion and said glass-opposing portion of said frame body, wherein said edge of said door glass can enter said glass guide portion.

6. (canceled)

7. The method of producing a vehicle door frame according to claim 1, wherein said projection width of said inwardly projecting portion of said exterior member in said direction toward said inner periphery of said door frame is greater in said side sash portion than in said upper sash portion.

8. The method of producing a vehicle door frame according to claim 1, wherein said inwardly projecting portion of said exterior member is formed from a hemmed portion which clamps said design portion of said frame body between an area of a design surface positioned on said vehicle exterior side and a folded area on said vehicle interior side.

9. The method of producing a vehicle door frame according to claim 1, wherein said inwardly projecting portion of said exterior member is formed from an empty hemmed portion which allows a folded area on said vehicle interior side to face an area of a design surface positioned on said vehicle exterior side.

10. The method of producing a vehicle door frame according to claim 1, wherein said exterior member is structured as an integral member.
